(19) United States
(12) Patent Application Publication
(10) Pub. No.: US 2005/0023090 A1
(43) Pub. Date: Feb. 3, 2005

(54) Disc brake

(76) Inventor: John Edmund Mackiewicz, Niles, MI (US)

Correspondence Address: Leo H. McCormick Jr., 2112 Mishawaka Avenue, P.O. Box 4721, South Bend, IN, 46634, US

(21) Appl. No.: 10/630,993

(22) Filed: Jul. 30, 2003

(51) Int. Cl. F16D 65/38

(52) U.S. Cl. 188/218 XL; 188/73.39

(57) ABSTRACT

A disc brake having an anchor with first and second rails that align first and second friction members with a rotor. The friction members each have a carrier with a first projection on a first end and a second projection on a second end that are respectively located in the first and second rails to position the first friction member on a first side of the rotor and the second friction member on a second side of the rotor. During a brake application, the first projection on the first carrier is pushed into engagement with a first abutment surface on the first rail prior to the second projection thereon engaging a first abutment surface on the second rail. At the same time the first projection on the second carrier is pulled into engagement with a second abutment surface on the second rail prior to the second projection thereon engaging a second abutment surface on the first rail and as a result the second projection on the first carrier and the second projection on the second carrier may sequentially pivot whenever the friction members encounter a thickness variation in the rotor to eliminate the introduction of axial stress forces at the point of the abutment engagement of the carries.

This invention relates to a disc brake having a first friction member with an engagement end of a carrier that is pushed into contact with a first abutment and a second friction member with an engagement end of a carrier that is pulled into contact with a second abutment to oppose the rotation of a rotor during a brake application such that the non-engagement end of the carriers may pivot about the engagement ends to allow a variation in the thickness of the rotor to pass there between without the introduction of axial stress force into a caliper of the disc brake and resulting brake torque variance.

### BACKGROUND OF THE INVENTION

Disc brakes such as illustrated in U.S. Pat. Nos. 4,044,864; 4,219,106; 4,335,806 and 5,551,537 have an anchor with support surfaces or rails that are spaced apart from each other to receive and guide first and second friction pads toward a rotor during a brake application. In such disc brakes, the first and second friction pads each have a carrier member that is retained in the first and second rails on an anchor to distribute frictional forces into the anchor during a brake application. The shape of the carriers may be different as illustrated in U.S. Pat. Nos. 5,111,914 and 6,039,155 wherein the carrier members and the rails have matched concave and convex surfaces through which brake forces are transmitted during a brake application rather than straight and parallel surfaces. In all of the above-identified patents, the carrier members distribute braking forces into adjacent abutments on a same support member of a rail. The structural arrangement of these disc brakes perform in an adequate manner as long as the thickness of a rotor remains uniform, unfortunately after a period of use, a wear pattern may develop such that the thickness of a rotor is not uniform and as a result high and low spots are created on the rotor surface. While an operator may experience the effect of a non uniform rotor as a surge action as brake judder during a brake application, investigation of the disc brake would also reveal that considerable axial stress or thrust force is introduced into the support members whenever a high sport on a rotor passes between the adjacent abutment engagement surfaces of the carriers and the rail on the support member of the anchor.

### SUMMARY OF THE INVENTION

It is a primary object of this invention to substantially eliminate the introduction of axial stress forces into an anchor for a disc brake by allowing a free end of a first carrier for a first friction member that is pushed into a first abutment on the anchor and a free end of a second carrier for a second friction member that is pulled into a second abutment on the anchor to sequentially pivot whenever the first and second friction members encounter a variance in the thickness of a rotor and as a result the thickness variance will not introduce an axial thrust force into the support members of the anchor.

According to this invention, a disc brake has an anchor fixed to a housing with first and second rails that align first and second friction members in parallel planes on opposite sides of a rotor. The first and second friction members are respectively moved into engagement with first and second radial surfaces on the rotor and develop a brake force that is communicated into the anchor to opposes the rotation of the rotor to effect a brake application. The thickness of the rotor between corresponding arcuate positions on the first and second radial surfaces with respect to an axis of rotation may vary and as a result the rotor may have high spots and low spots with respect to radial planes defined by a thickness of the rotor. The first and second friction members each have a carrier with a first projection on a first end and a second projection on a second end. The first projection on the carrier for the first friction member is located in the first rail and the second projection thereof is located in the second rail in a first plane that is substantially parallel with the first radial surface on the rotor. Similarly, the first projection on the carrier for the second friction member is located in the second rail and the second projection thereof is located in the first rail in a second plane that is substantially parallel with a second radial surface on the rotor. During a brake application, a force is applied to the carriers to move pads on the first and second friction members into engagement with the rotor. When a pad on the first friction member engages the first radial surface of the rotor, the first projection on the first carrier is pushed into engagement with a first abutment surface on the first rail prior to the second projection thereon engaging a first abutment surface on the second rail. At the same time, when a pad on second friction member engages the second radial surface, the first projection on the second carrier projection is pulled into engagement with a second abutment surface on the second rail prior to the second projection thereon engaging a second abutment surface on the first rail. With only the first projections on the first and second carriers axially restrained, the second projection on the first carrier member and the second projection on the second carrier may sequentially pivot whenever the pads on the first and second friction members encounter thickness variations in the rotor and as a result axial torsion stress forces are not introduced into the anchor at the respectively points of engagements of the of the first projections with the abutment surfaces on the anchor.

An advantage of this invention resides in the use of a first carrier for a first friction member that is pushed into engagement with a first abutment surface and a second carrier for a second friction member that is pulled into engagement with a second abutment surface during a brake application such that the first friction member and second friction member may sequentially pivot whenever the first and second friction member encounter a variation in thickness of a rotor and as a result axial stress forces are not introduced into the anchor.

### BRIEF DESCRIPTION OF THE DRAWINGS

FIG. 1 is a schematic illustration of a disc brake according to the present invention having support rails in an anchor for receiving an outboard carrier member for a friction member;

FIG. 2 is a sectional view taken along lines 2-2 of FIG. 1;

FIG. 3 is a sectional view taken along lines 3-3 of FIG. 1;

FIG. 4 is a sectional view taken along lines 4-4 of FIG. 2 showing the engagement of the outboard first friction member with a first abutment surface on an anchor during a brake application;

FIG. 5 is a schematic illustration of an outboard carrier member for a friction member located support rails in the anchor for the disc brake of the present invention;

FIG. 6 is a sectional view taken along lines 5-5 of FIG. 2 showing the engagement of the inboard friction member with a second abutment surface on an anchor during a brake application;

FIG. 7 is a schematic illustration showing the relationship between the carriers for inboard and outboard friction members and a rotor in a typical prior art disc brake;

FIG. 8 is an enlarged schematic illustration showing a relationship between a rotor and inboard and outboard friction members of the present invention during a brake application; and

FIG. 9 is a sectional view of a second embodiment of carriers for the first and second friction members for use in a disc brake according to the present invention.

### DETAILED DESCRIPTION

In this description a same number may be used for a feature in describing a same component when used in a different locations or it necessary ′ may be added to the original number.

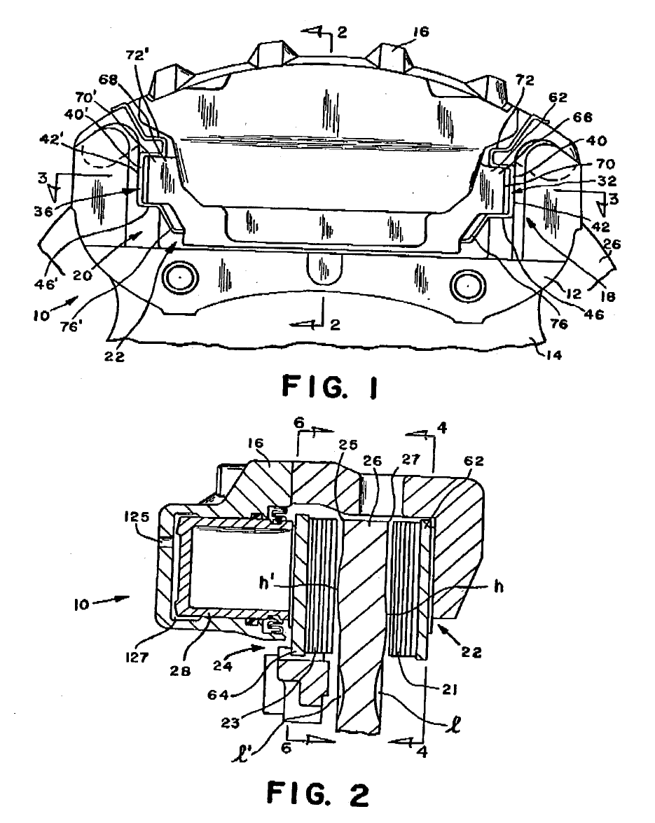

FIGS. 1, 2, 3 and 5 illustrate a disc brake 10 made according to the present invention for use in a brake system of a vehicle. The disc brake 10 includes an anchor 12 that is fixed to the housing 14 and a caliper 16 that is mounted to slide on the anchor 12. Anchor 12 includes a first rail 18 that has two spaced apart support members 32 and 34 and a second rail 20 that has two spaced apart support members 36 and 38. The anchor 12 is attached to the housing such that the first rail 18 and the second rail are aligned in a manner to be perpendicular to a rotor 26. The first 18 and second 20 rails retain, guide and support first 22 and second 24-friction member that are located on opposite sides of the rotor 26. To effect a brake application, pressurized fluid is supplied through port 125 to a chamber 127 in caliper 16. The pressurized fluid in chamber 27 acts on a piston 28 to move a pad 23 on the second friction member 24 into engagement with rotor 26 and acts on caliper 16 to move a pad 21 on the first friction member 22 into engagement with the rotor 26. When the pads 21 and 23 on the first and second friction members 22 and 24 engages the radial surfaces on the rotor 26, a brake force develops that is carried into the first 18 and 20 rails to oppose the rotation of rotor 26 and thereby effect a corresponding brake application. This engagement of the first friction member 22 with the first rail 18 and the second friction member 24 with the second 20 rail hold the first 22 and second 24 friction members in a parallel relationship with rotor 26 during the brake application such that a resulting brake force is directly communicated into the anchor 12 without the introduction of any lateral forces that may cause judder.

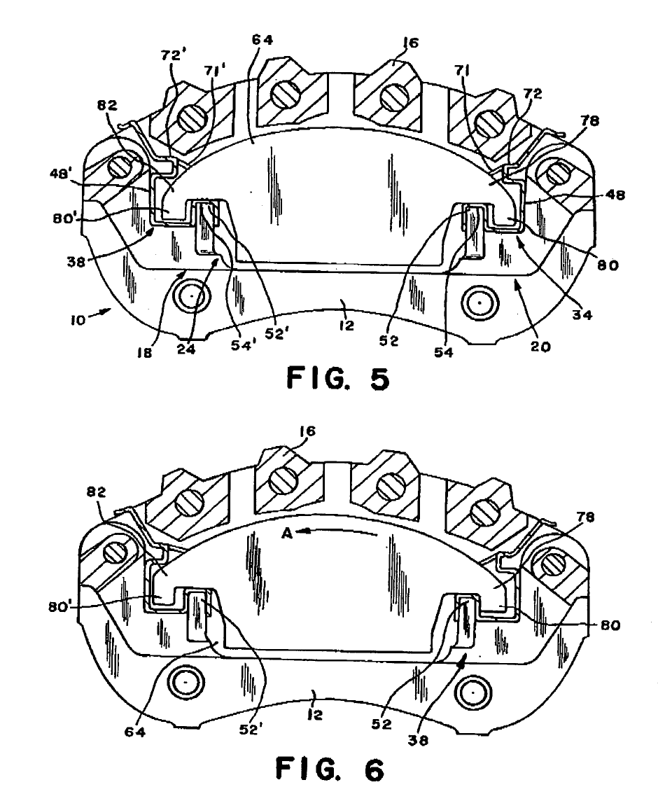

In more particular detail, the first rail 18 in anchor 12 is defined by a first support member 32 that is separated from a second support member 34 by a first bridge 35 while the second rail 20 is defined by a first support member 36 that is separated from a second support member 38 by a second bridge 35′. The first support members 32 on the first rail 18 and the first support member 36 on the second rail 20 are identical and located on a first or outboard side of the anchor 12, see FIG. 1, while the second support members 34 on the first rail 18 and the second support member 38 on the second rail 20 are also identical and located on a second or inboard side of the anchor 12, see FIG. 5. Support member 32 and 36 are defined by a substantially rectangular slot 40,40′ with an abutment surface 42,42′ located adjacent a aligning surface 46,46′ as best illustrated in FIGS. 1 and 4 while support members 34 and 38 are defined by a rectangular slot 48,48′ with a constraining surface 52,52′ and a bearing surface 54,54′ as shown in FIG. 5. The first support members 32 and 36 are shaped to receive a backing plate or carrier 62 for the first friction member 22 that pushes on the anchor 12 while the second support members 34 and 38 are shaped receive a backing plate or carrier 64 for the second friction member 24 that pulls on the anchors 12.

The backing plate or carrier 62 for the first friction member 22 is best shown in FIGS. 1, 3 and 4 and is shaped with a first end 66 having a substantially rectangular projection 70 thereon and a second end 68 having a substantially rectangular projection 70′ thereon. The first rectangular projection 70 is complimentary to the rectangular slot 40 in the first support member 32 of the first rail 18 while the second rectangular projection 70′ is complimentary to the rectangular slot 40′ in second support member 36 of the second rail 20. Respectively locating projection 70 in rectangular slot 40 and projection 70′ in rectangular slot 40′ aligns the first friction member 22 in a plane that is parallel with radial surface 27 on rotor 26. Slippers or guides 72,72′ are respectively located in rectangular slots 40,40′ of anchor 12 and a portion thereof is located between the first projections 70,70′ and anchor 12. The slippers or guides 72,72′ have a leg 76,76′ that acts on the carrier 62 to respectively urge the projections 70 and 70′ into engagement with the first rails 18 and 20 to prevent noise caused by rattling of the components.

Backing plate or carrier 64 for the second friction member 24 is best shown in figures3 and 5 and is shaped to include a first end 78 with a first projection 80 thereon that is defined by a hook that is complimentary to rectangular slot 48 in the second support member 38 of the second rail 20 and a second end 82 with a second projection 80′ thereon that is defined by a hook that is complimentary with a rectangular slot 48′ in the second support member 34 in the first rail 18. Respectively locating projection 80 in rectangular slot 48′ and projection 80′ in rectangular slot 41′ aligns the friction pad 23 in a plane that is parallel with radial surface 25 on rotor 26. A portion of slippers or guides 72,72′ respectively extend into rectangular slots 48,48′ from slots 40,40′ and are located between projections 80′,80 and the anchor 12. The slippers or guides 72,72′ each have an additional leg 71,71′ that acts on the carrier 64 to urge the projections 80,80′ into engagement with bearing surfaces 54′,54 in the rails 18 and 20 to prevent noise caused by rattling of the components.

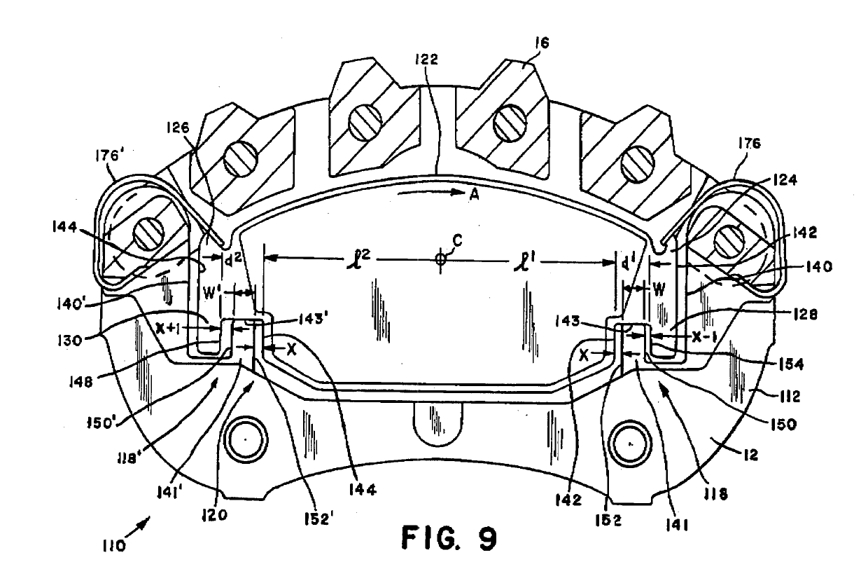

For some applications, it may be easier to manufacture a disc brake wherein both the inboard and outboard carriers are identical such as the common backing plate or carrier 122 illustrated in FIG. 9 for use in a disc brake 110. The carrier 122 for both a first and second friction member 120 would have a same shape and function in a similar manner as described above with respect to the dis-similar carriers 62 and 64 for the friction members 22 and 24. In more detail, in disc brake 110, the rectangular slot 140 in the first rail 118 and rectangular slot 140′ in the second rail 118′ of anchor 112 have an identical shape and the linear width “w” for the bearing surface between a first surface 150 and a second surface 152 on projection 141 and between a first surface 150′ and a second surface 152′ on projection 141′ of anchor 112 are also identical. The backing plate or carrier 122 for the friction member 120 has an arcuate shape with a first end 124 and a second end 126. The first end 124 has a projection 128 that is defined by a hook or constraining shape that is complimentary with a projection 141 adjacent rectangular slot 140 of the first rail 118 and a second end 126 has a projection 130 that is defined by a hook or constraining shape that is complimentary with a projection 141′ adjacent rectangular slot 140′ for the second rail 118′ of anchor 112. The backing place or carrier 122 is defined by a first arcuate length l1 between a radial center “c” and a first face 142 on the first end 124 and a second arcuate length l2 between the radial center “c” and a second face 144 on the second end 126 which are the same while a distance “d1” between the first face 142 and a first face 154 on projection 128 and a distance “d2” between the second face 144 and a second face 148 on projection 130 are different, with “d₂” being larger that “d₁”. The distances “d₁” and “d₂” are selected such that with the carrier 122 centered between the first and second projections 141,141′ a clearance distance of “x” exits between faces 142 and 144 on carrier 122 and face 152 on projection 141 and face 152′ on projection 141′ with the carrier 122 centered between the first rail 118 and the second rail 118′. Since the width “w” for the bearing surfaces on projections 141,141′ are the same, a smaller clearance distance “x−1” exist between face 150 on projection 141 of rail 118 and face 124 on projection (hook) 128 on the first end 124 and a larger clearance “x+1” exists between face 150′ on projection 141′ and a face 148 on projection 130 on the second end 126. As with the carriers 62 and 64 for disk brake 10, when projections 128 and 130 of the friction members 200 are respectively located in rails 118 and 118′, the friction members 122,122′ are located in planes that are parallel with radial surface 25 and 27 on rotor 26. Slippers or guides would be provided to cover slots 140,140′ and projections 141,141′ to provide a smooth surface on which the ends 124 and 126 move with respect to rotor 26. In addition, hold down springs 176,176′ acts on the carriers 122,122′ to urge the projections 128, 130 into engagement with bearing surfaces 143,143′ on rails 118 and 118′ to prevent noise caused by rattling of the components.

The rotor 26 has a first radial surface 25 and a second radial surface 27 that are initially defined by parallel planes but after a period of time because of wear changes in the thickness of the rotor may develop. The changes in thickness create a plurality of high (h,h′) and low (l,l′) spots with respect to an initial flat surface of the rotor. The high (h,h′) and low (l,l′) spots on the surfaces may create a serpentine shape in the rotor 26 and as a result engagement with the first 22 and second 24 friction members may produce judding that is carried back to the brake pedal.

### Mode of Operation of the Disc Brake

In a vehicle equipt with a disc brake 10, when an operator desires to effect a brake application, pressurized fluid is communicated to chamber 127 that acts on piston 28 to move a pad 23 on the second friction member 24 into engagement with rotor 26 and acts on caliper 16 to move a pad 21 on the first friction member 24 into engagement with the rotor 26 to develop a braking force. When pad 21 on the first friction member 22 engages radial surface 27 on rotor 26, backing plate or carrier 62 is rotated and rectangular projection 70 of the first end 66 is moved into engagement with abutment surface 42 on the first rail 18, see FIGS. 4 and 8, and thereafter approximately one half of a resulting braking force is carried in to the anchor 12 through this point of engagement. The first friction member 22 may hereinafter be referred to as being pushed into engagement with the anchor 12. It should be understood at this time and during the brake application rectangular projection 70′ on the second end 68 is not restrained with respect to abutment surface 42′ but may pivot with respect to this engagement point 15. Similarly, when pad 23 on the second friction member 24 engages the radial surface 25 on the rotor 26, backing plate 64 is rotated and the hook defined by the first projection 80 on the first end 78 is brought into engagement with constraining surface 52 on the support member 38 of the second rail 20, see FIG. 6, and thereafter the other one half of the braking force is carried into the anchor 12 at this engagement point 13. The second friction member 24 may hereinafter be referred as being pulled into engagement with the anchor 12. It should be understood at this time and during the remainder of the brake application the hook defined by the second projection 80′ on the second end 82 is not restrained with respect to constraining surface 52′ but may pivot with respect to this engagement point.

As long as the radial surfaces 25 and 27 on rotor 26 are smooth friction pad 21 on the first friction member 22 and friction pad 23 on the second friction member 24 respectively uniformly engage radial surface 25 and 27 to develop braking forces that are carried into the first 18 and 20 rails to oppose the rotation of rotor 26 and thereby effect a corresponding brake application. This engagement of the first friction member 22 with the first rail 18 and the second friction member 24 with the second 20 rail hold the first 22 and second 24 friction members in a parallel relationship with rotor 26 during a brake application such that a resulting brake forces F1 and F2 are directly communicated into the anchor 12 without the introduction of any lateral forces.

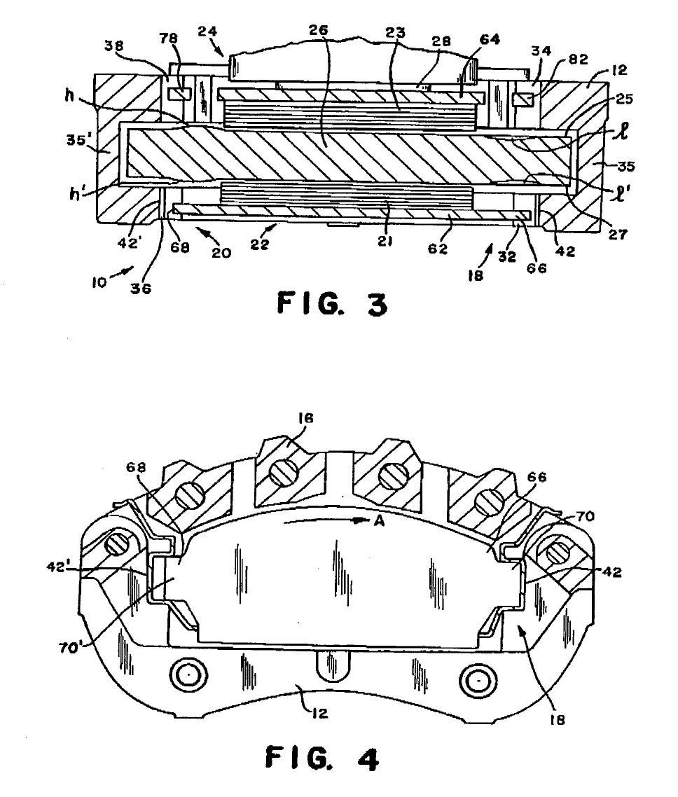

Unfortunately, after a period of time, rotor 26 may wear in a non-uniform manner such that high (h,h′) and low (l,l′) spots are located on the radial surface 25 and 27, see FIG. 3, and in an extreme situation, the thickness may appear approach a serpentine shape.

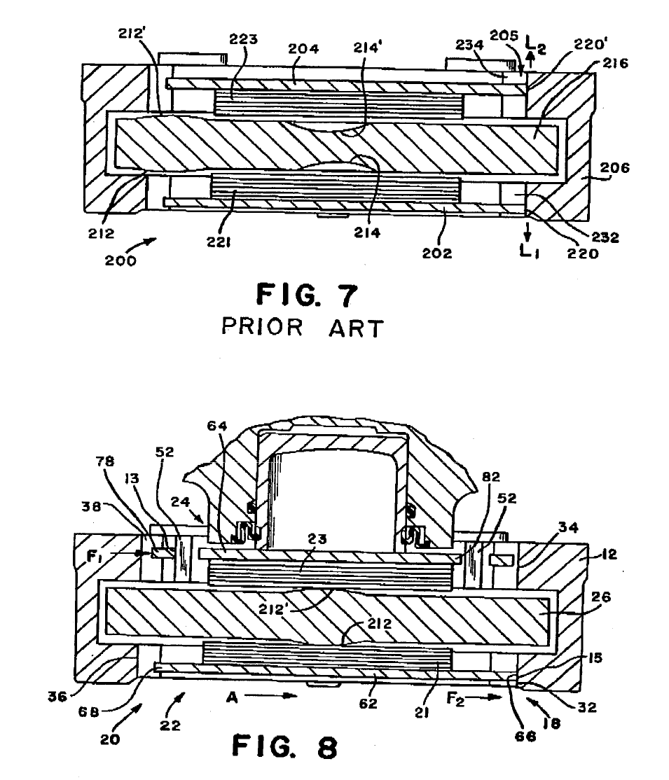

In prior art disc brake 200, wherein a rotor 216 has worn in a manner such than high 212,212′ and low 214,214′ spots are present the non-uniform radial surfaces present, a problem occurs when the high spots 212,21′ pass between the point of engagement of the carriers of the first and second friction members and the abutment surfaces on a rail. In FIG. 7, a disc brake is illustrated for a carrier whereby braking forces are communicated through engagement points 220,220′ for a first friction member 202 and a second friction member 204 are carried into an a same rail 205 of anchor 206. Whenever a high spot 212,212′ on the rotor 26 passes between the engagement points 220,220′, the friction members 202,204 must move radially with respect to the rail 205 or axial strain or forces L1 and L2 are introduced into the anchor 206 at the engagement points 220,220′. The high spots 212,212′ on rotor 216 on move toward the engagement points 220,220′ and introduce lateral forces L1 and L2 that must first overcome the arcuate braking forces F1 and F2 that are being transmitted into the rail 205 before any lateral movement occurs and as a result considerable stain may be introduced into the carriers 202 and 204. The stain produced during a brake application is referred as judder and inaddition to noise may in an extreme situation produce feed back that is felt by an operator as surging. The disc brake 200 as illustrated in FIG. 7 is pusher but the same situation would exist for a puller in that the braking forces for both a first carrier and a second carrier are transmitted into a same rail in an anchor and the high spots would exert an force in moving past the point of engagement.

The structure of disc brake 10 essentially eliminates the introduction of judder as the free end 68 on the first friction member 22 (the pusher) and the free end 82 on the second friction member 24 (the puller) pivot when engaged by the high spots 212,212′ such that lateral stress or force is not introduced into the anchor 12 at the engagement points 13,15. As illustrated in FIG. 8, when a rotor 26 is rotating in the direction of arrow A, when a high spot 212 engages the friction pad 21 on the first friction member 22 adjacent the second rail 20 and causes free end 68 of the carrier 62 to pivot outwardly about the engagement point 15 of end 70 and support member 32 of rail 18. As high spot 212 rotates toward the first rail 18, the high spot 212 now acts on the friction pad 23 on the second friction member 24 to pivot carrier 64 about the hook defined by projection 80 and constraining surface 52 of the first end 78 while allowing free end 70′ on the second end 82 to pivot and move in rail 34. Thus, the introduction of lateral forces (l,l′) into an anchor 12 by a rotor 26 with high spots 212,212′ thereon is essentially eliminated through the sequential pivoting of the first 62 and second 64 carriers for the first 22 and second 24 friction members.

The second embodiment for the invention for a disc brake 110 as illustrated in FIG. 9 having identical carriers 120 would function in a similar manner as follows. It is assumed that the rotor 26 is rotating in the direction of arrow A and on receipt of pressurized hydraulic fluid the piston would act on carrier 122′ of the inboard friction member 120′ while the caliper would act on the carrier 122 of the outboard friction member 120 to respectively urge pads into engagement with rotor 26. On engagement with rotor face 25, the outboard friction member 120 is rotated in the direction of arrow A toward the first rail 118 such that face 142 on the first end 124 is moved distance x and into engagement with face 152 on projection 141 while face 148 on end 130 never contacts face 150′ as the distance x+1 is greater that distance x and as a result the outboard friction member 120 acts as pusher such that.projection 130 is not constrained by the second rail 118′. At the same time the inboard friction member 120′ is rotated toward the first rail 118 such that face 154 on the first end 124 engages face 150 on projection 141 while face 148 on projection 130 of the second end 126 never contacts face 150′ on projection 141′ as the distance x−1 is less that the distance x and as a result the inboard friction member 120′ as a puller as the projection 130 is not constrained by the first rail 118. When a high spot 212,212′ on the rotor 26 engages the pads, the carrier 122 for the outboard friction member 120 pivots about the engagement point on the first rail 118 to allow the free or second end 126 to move a lateral distance corresponding to the high spot 212 and as a result lateral forces are not introduced into the anchor 112. As a high spot 212,212′ on the rotor 26 continues to move toward the first rail 118, the high spot 212,212′ will act on the second friction member 120′ such that carrier 122′ pivots about the first end 124 and as a result the second end 126 is free to laterally move and as a result the high spot 212 move between the entrance and exit engagement with the pads without the introduction of lateral forces into the anchor 112.

It should be understood that the description of the functional action of disc brakes 10 and 110 are with a vehicle traveling in a forward direction but the features would equally apply when the vehicle is moving in reverse as the opposite ends of the carriers would then come into engagement the appropiate support members such that pivoting could occure and allow a high point to past between the points of engagement. Disc brakes 10 and 110 equally perform in a same manner in reducing the introduction of lateral stress into an anchors 12 and 112 and as a result judding is essentially eliminated during a brake application.

1. A disc brake having an anchor fixed to a housing, said anchor having first and second rails that align first and second friction members with a rotor, said first and second friction members being respectively moved into engagement with first and second radial surfaces on said rotor to develop a brake force that opposes the rotation of said rotor to effect a brake application, said brake force being communicated through said first and second friction members into said anchor during the brake application characterized in that a thickness of said rotor between corresponding positions on said first and second radial surfaces may vary; and in that said first rail has a first section and a second section each of which has a constraining surface separated from a bearing surface; and in that said second rail has a first section and a second section each of which has a constraining surface separated from a bearing surface; and in that said first friction member has a first carrier with a first projection on a first end and a second projection on a second end, said first projection on said first carrier being located adjacent said constraining surface in said first section of said first rail and said second projection being located adjacent said constraining surface in said first section of said second rail; and in that said second friction member has a second carrier with a first projection on a first end and a second projection on a second end, said first projection on said second carrier being located adjacent said constraining surface in said second section of said second rail and said second projection being located adjacent second constraining surface in said second section of said first rail; and in that said first projection on said first carrier and said first projection on said second carrier respectively engage said bearing surface of said first section of said first rail and said constraining surface of said second section of said second rail during a brake application such that second projection on said first carrier may pivot with respect to said first projection and said second projection on said second carrier may pivot with respect to said first projection on said second carrier when said first and second friction members encounter thickness variations in said rotor.

2. The disc brake as recited in claim I wherein the pivoting of said second projection with respect to the first projection on the first carrier and the pivoting of the second projection with resect to the first projection on the second carrier sequentially occurs to eliminate and lateral force on the engagement of said first projection on said first carrier with said bearing surface of said first section of said first rail and said first projection on said second carrier with said constraining surface of said second section.

3. The disc brake as recited in claim 2 wherein a first space relationship between said first projection on said first carrier and said constraining surface in said first section of said first rail is less than a second space relationship between said second projection on said first carrier and said constraining surface in said first section of said second rail.

4. The disc brake as recited in claim 2 wherein a third space relationship between said first projection on said second carrier and said constraining surface in said second section of said second rail is less than a fourth space relationship between said second projection on said second carrier and said constraining surface in said second section of said first rail.

5. The disc brake as recited in claim 4 wherein said first space relationship and said third space relationship are identical and as a result braking force developed during a brake application are equally carried into said first rail and second rails.

6. The disc brake as recited in claim 2 wherein said pivoting of first and second carriers reduces brake torque surge during a brake application.

7. The disc brake as recited in claim 1 wherein said first carrier and said second carrier are further characterized by first and second ears, and in that spring means engage said first and second ears to urge said first and second carriers toward said first and second rails to prevent rattling.

8. A disc brake having an anchor fixed to a housing, said anchor having first and second rails that align first and second friction members with a rotor, said first and second friction members on being respectively moved into engagement with first and second radial surfaces on said rotor developing a brake force that is communicated into said anchor to opposes the rotation of said rotor to effect a brake application, said rotor being characterized by having a thickness that may vary between corresponding arcuate positions on said first and second radial surfaces with respect to an axis of rotation; and in that said first friction member has a first carrier with a first projection on a first end and a second projection on a second end, said first projection on said first carrier of said first friction member being located in said first rail and said second projection thereof being located in said second rail to align said first friction member in a first plane substantially parallel with said first radial surface on said rotor; and in that said second friction member has a second carrier with a first projection on a first end and a second projection on a second end, said first projection on said second carrier being located in said second rail and said second projection thereof being located in said first rail to align said second friction member in a second plane substantially parallel with said second radial surface of said rotor; and in that said first projection on said first carrier is pushed into engagement with a first abutment surface on said first rail and in that first projection on said second carrier projection is pulled into engagement with a second abutment surface on said second rail and as a result said second projection on said first carrier member and said second projection on said second carrier may sequentially pivot whenever said first and second friction members encounter thickness variations in said rotor such that the introduction of stress forces on the first projections at the respective points of engagement with the abutment surfaces is prevented.

9. The disc brake as recited in claim 8 wherein said a first space relationship between said first projections on said first and second carriers and said first and second rails is characterized as being less than a second space relationship between said second projections on said first and second carriers and said first and second rails and as a result when a rotor is rotating in a forward direction said first projections will always engage an abutment surface before said second projections engage an abutment surface.

10. The disc brake as recited in claim 9 wherein said pivoting of said first and second carriers reduces the introduction surging during a brake application.

11. The disc brake as recited in claim 8 wherein said second projections on said second ends of said first and second carriers engage first and second rails when a vehicle is traveling in a reverse direction to prevent the development of stress force into an anchor when a high thickness on a rotor passes between the first and second friction members.
